(19) United States
(12) Patent Application Publication
(10) Pub. No.: US 2006/0045167 A1
(43) Pub. Date: Mar. 2, 2006

(54) Self-contained temperature monitor

(76) Inventors: Ivan Pawlenko, Holland, PA (US); Larry Samson, Langhorne, PA (US)

Correspondence Address: HARNESS, DICKEY & PIERCE, P.L.C., P.O. Box 8910, Reston, VA, 20195, US

(21) Appl. No.: 10/927,143

(22) Filed: Aug. 27, 2004

(51) Int. Cl. G01K 1/14; G01K 1/08; G01K 13/00

(52) U.S. Cl. 374/148; 374/141

(57) ABSTRACT

A self-contained temperature monitor is provided for use in combination with a range of plumbing fixtures and piping through which liquid will flow either continuously or periodically. The temperature monitor typically includes a main body, a temperature sensor, a processing unit and a indicator means, such as a digital display or an array of light emitting devices, for conveying the sensed temperature information to a user. Various configurations of the temperature monitor provide for temporary or more permanent mounting on plumbing fixtures, particularly faucets, and pipes.

### BACKGROUND OF THE INVENTION

The present invention relates to a self-contained temperature monitor for a water supply line or other supply line. More particularly, this invention concerns a self-contained temperature monitor that can be installed in a substantially permanent or temporary fashion, typically near the outlet of a liquid supply line, to advise the user or others in the vicinity as to the temperature of the liquid exiting or flowing through the supply line.

The temperature of a liquid within a supply line or exiting a supply line is a common factor in determining the suitability of the liquid for its intended use including, for example, uses such as bathing, sanitizing or chilling. As will be appreciated given the importance of this parameter, a number of devices have been developed to monitor and, in some instances, to control, the temperature of a liquid flow. A variety of inline devices for monitoring liquid temperature are disclosed in, for example, U.S. Pat. Nos. 4,630,940, 5,199,790 and 6,641,305 B2, in which a temperature sensor and a display are arranged and configured to form an intermediate or an outlet portion of the liquid flow channel.

Although such devices are able to provide temperature information, they are generally dedicated to a particular application and cannot be readily moved or easily retrofitted onto other plumbing fixtures and lines. There is a need, therefore, for temperature monitors that are more easily and readily adapted to various applications and may be used for retrofit applications.

### SUMMARY OF THE INVENTION

The present invention is a self-contained temperature monitor and indicator that may be arranged and configured for use with most standard plumbing fitting and lines and may provide for temporary or substantially permanent mounting to a plumbing fitting or line. Each self-contained temperature monitor may include a housing, a mounting means and a temperature indicator. Some embodiments may also include one or more power supply or power generation means, a noise generator and/or a programming means that allows the user to set certain parameters and responses.

Exemplary embodiments of a self-contained temperature monitor according to the present invention typically includes a main body, a power supply, a processing unit configured to receive power from the power supply, a temperature probe configured for conveying data corresponding to a sensed temperature to the processing unit and a temperature indicator configured for emitting at least one audio and/or visual signal corresponding to control signals received from the processing unit corresponding to the sensed temperature.

Exemplary embodiments of fluid delivery systems incorporating a self-contained temperature monitor according to the present invention typically include a fluid supply, a fluid passage connected to the fluid supply, and a self-contained temperature monitoring device mounted on the fluid passage for detecting and indicating the temperature of the fluid flowing in and/or exiting from the fluid passage. It is anticipated that the present invention will have particular utility in homes, daycare hospitals, nursing homes and other assisted living facilities for monitoring bathing water temperature, in food service or laboratory applications for monitoring sanitation or heating fluids, and in brewery or laboratory applications for monitoring chilling fluids, fermentation vessels and reactant solutions.

### BRIEF DESCRIPTION OF THE DRAWINGS

The above and other features and advantages of the present invention will become more apparent by describing in detail exemplary embodiments thereof with reference to the attached drawings in which:

FIGS. 1A-1B illustrate a first embodiment of the invention;

FIGS. 2A-2B illustrate a second embodiment of the invention;

FIGS. 3A-3B illustrate a third embodiment of the invention;

FIG. 4 illustrates a fourth embodiment of the invention;

FIGS. 5A-5B illustrate a fifth embodiment of the invention;

FIGS. 6A-6B illustrate a sixth embodiment of the invention; and

FIGS. 7A-7C illustrate a seventh embodiment of the invention.

These drawings have been provided to assist in the understanding of the exemplary embodiments of the invention as described in more detail below and should not be construed as unduly limiting the invention. In particular, the relative spacing, positioning, sizing and dimensions of the various elements illustrated in the drawings are not drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

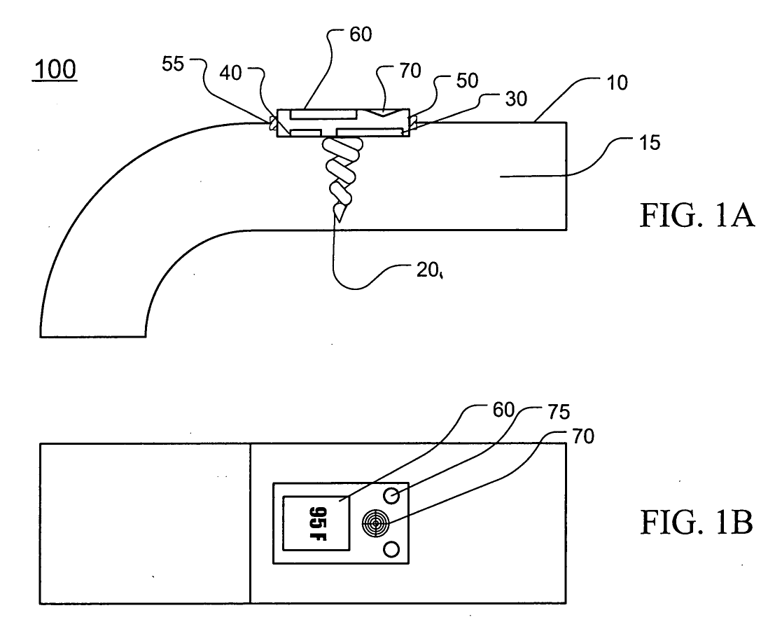

As illustrated in FIG. 1A, a first exemplary embodiment of a temperature monitor 100 is shown mounted in an opening provided on a top surface of a faucet 10 that has a flow channel 15 running through it for delivering a liquid, such as water. The temperature monitor 100 includes a main body 50 that is sealed within a corresponding opening provided on the top surface of the faucet by a gasket 55, adhesive or other attachment methods to form a liquid-tight seal around the periphery of the main body. Contained within or attached to the main body 50 are a temperature probe 20, such as a thermocouple or temperature sensitive semiconductor chip, a processor unit 30, an energy source 40, such as a battery, a display 60, such as an LCD or LED display, and a speaker or annunciator 70.

As illustrated in FIG. 1A, the temperature monitor is mounted on the faucet with the temperature probe 20 extending into the flow channel 15 where it will contact liquid flowing through the flow channel 15. The temperature probe 20 will typically generate a current and/or voltage value or other data corresponding to the temperature of the liquid in which the temperature probe is immersed. The value or data from the temperature probe 20 will be received by the processor unit 30 that, in light of its programming, will determine how to display and/or announce the temperature measured by the temperature probe.

For example, as illustrated in FIG. 1B, the temperature monitor unit may include one or more buttons or switches 75 that will allow a user to program certain parameters such as switching the display mode between ° C. and ° F., setting a high temperature alarm level, a low temperature alarm level and/or a preferred temperature and switching the annunciator mode between tone and/or speech modes. In a speech mode, the speaker 70 may utilize digital audio clips and/or a speech synthesizer in order to project the appropriate verbal signals. As will be appreciated, the “95 F” illustrated on the display 60 is illustrative only and the temperature monitor can be configured to display considerably higher temperatures, such as those encountered in food service or laboratory applications, and/or lower temperatures, such as those encountered in the brewery or laboratory applications. Similarly, the selection of the construction materials and the temperature probe will be guided by the intended application in order to select combinations of materials that are non-reactive and generally durable under the anticipated conditions.

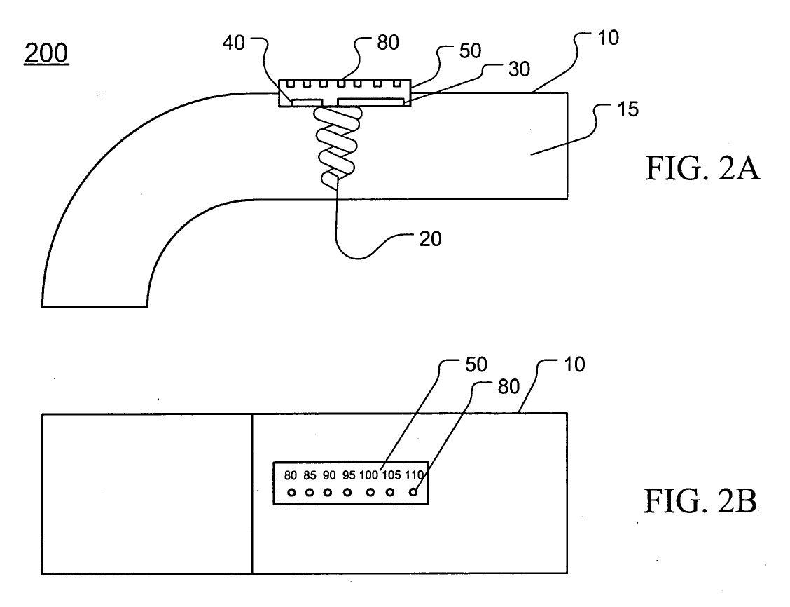

As illustrated in FIG. 2A, a second exemplary embodiment of the temperature monitor 200 is configured for mounting in an opening provided on a top surface of a faucet 10 that has a flow channel 15 running through it for deliver of a liquid, such as water. The temperature monitor includes a main body 50, a temperature probe 20, a processor unit 30, an energy source 40 and a plurality of light emitting devices 80 that cooperate to define a display. As illustrated in FIG. 2B, the light emitting devices 80 may be arranged in a single line and may be associated with particular temperatures with the corresponding light emitting device activated to indicate the measured liquid temperature.

Alternatively, the light emitting devices 80 may be configured to emit light of different wavelengths with a first light or plurality of lights activated, perhaps sequentially, to display a first color, such as blue as the measured liquid temperature approaches a desired temperature range, a second light or plurality of lights configured to display a second color, such as green, when the measured liquid temperature is within a desired temperature range, and a third light or plurality of lights configured to display a third color, such as red, when the measured liquid temperature exceeds the desired temperature range.

It will be appreciated that, depending on the programming of the processor unit 30, the light emitting devices may be used to convey additional information by selectively illuminating certain of the lights, shifting the color of the emitted light from one or more of the lights, flashing one or more of the lights and/or varying the frequency at which the lights are flashing, and/or some combination of the above. Similarly, the light emitting devices can be arranged in various configurations and/or may be of varying size and orientation that, in combination with color, sequence of illumination and frequency of illumination may be used to configure a large number of unique display means.

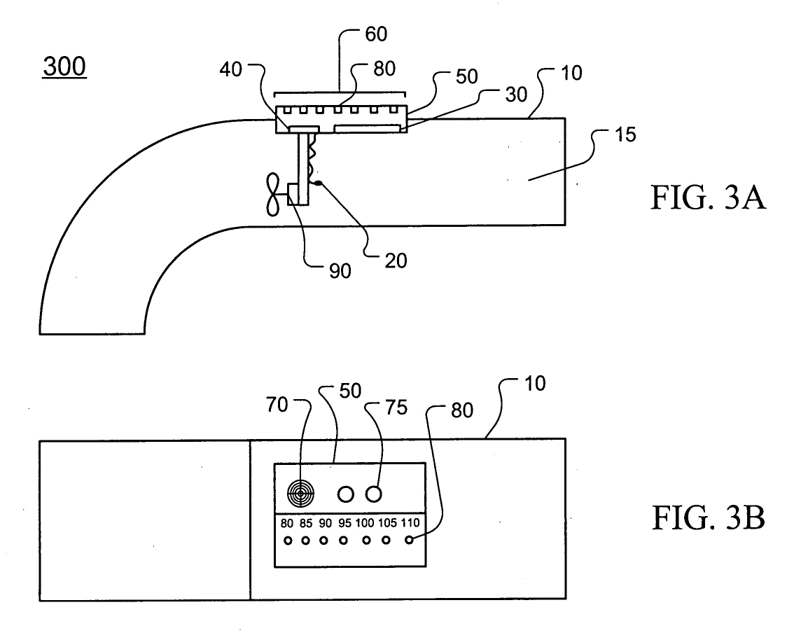

As illustrated in FIG. 3A, a third exemplary embodiment of the temperature monitor 300 is configured for mounting in an opening provided on a top surface of a faucet 10 that has a flow channel 15 running through it for delivering a liquid, such as water. The temperature monitor includes a main body 50 and contained within or attached to the main body are a temperature probe 20, a processor unit 30, an energy storage device 40, such as a battery or a capacitor, a display, in this instance a plurality of light emitting devices 80, and a generator unit 90. As shown in FIG. 3A, the generator unit 90 is preferably positioned within the flow channel 15 so that even a relatively low volume of liquid flowing through the flow channel will be sufficient to cause the shaft of the generator to rotate and produce power. Power not consumed by the display 60 and/or the processor unit 30 may be stored in the energy storage device 40 for providing energy to the temperature monitor to ensure its operation when the liquid flow is insufficient to operate the generator or the output of the generator unit 90 requires supplementary power to operate the temperature indicator properly.

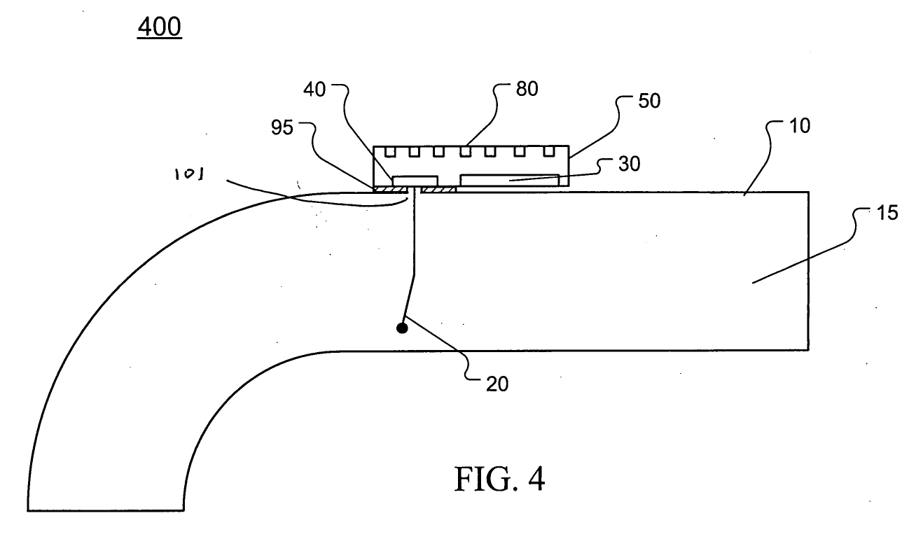

As illustrated in FIG. 4, a fourth exemplary embodiment of the temperature monitor 400 is configured for mounting primarily external to a relatively small opening provided on a top surface of a faucet 10 that has a flow channel 15 running through it for delivering a liquid, such as water. The temperature monitor includes a main body 50 that mounts to a portion of the top surface of the faucet. Contained within or attached to the main body are a temperature probe 20, a processor unit 30, an energy source 40, a display 60, and, optionally, a speaker or annunciator 70 (not shown). As indicated in FIG. 4, this embodiment requires that only a small opening 101 be formed through the walls of the faucet 10 to allow the operative tip of the temperature probe 20 to be inserted into the flow channel 15 of the faucet and positioned so that most, if not all, of the anticipated liquid flows will tend to submerge the tip of the temperature probe in the liquid. A gasket or other sealing composition 95 may be used to secure the temperature monitor to the faucet and form a substantially liquid-tight seal.

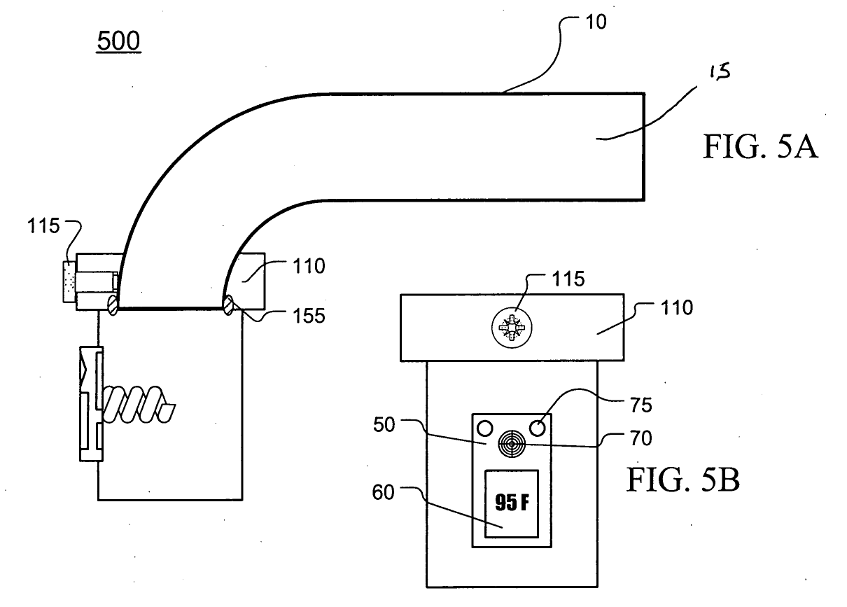

As illustrated in FIG. 5A, yet a fifth exemplary embodiment of the temperature monitor 500 is configured for mounting adjacent an outlet opening of a faucet 10 that has a flow channel 15 running through it for delivering a liquid, such as water. The temperature monitor includes a collar portion 110 surrounding an outlet portion of the faucet 10. The collar portion may be configured for a substantially frictional fitting using resilient materials and/or may incorporate additional attachment devices such as screw 115 for providing a sufficiently stable, but readily removable, placement of the temperature monitor adjacent the outlet of the faucet 10. One or more gaskets 155, resilient flanges or other sealing materials may be used to form a liquid-tight seal between the temperature monitor and the faucet 10.

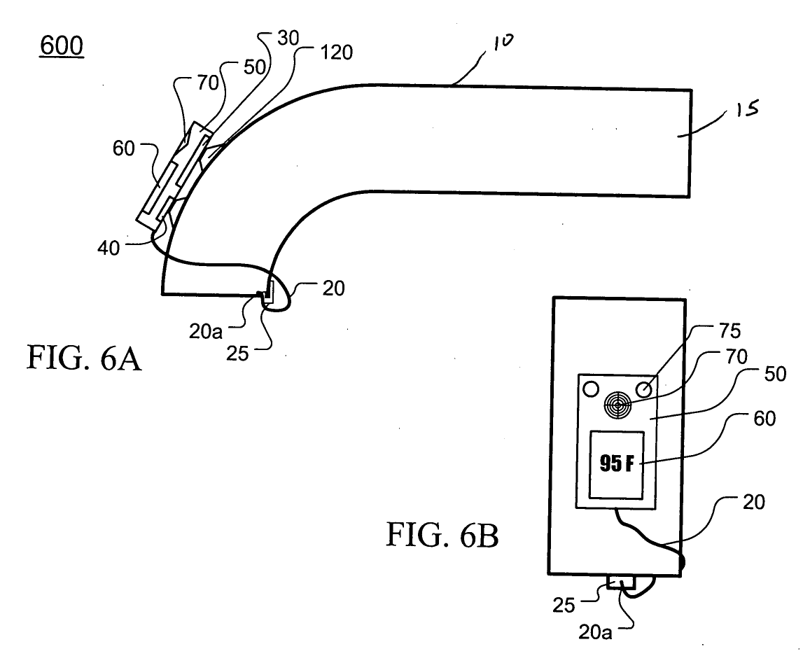

As illustrated in FIGS. 6A and 6B, a sixth exemplary embodiment of the temperature monitor 600 is configured for temporary mounting on the surface of a faucet 10 that has a flow channel 15 running through it for delivering a liquid, such as water. The temperature monitor includes attachment elements 120, such as one or more suction cups, magnets or hook-and-loop devices, that allow the temperature monitor to be easily and removably mounted to the surface of the faucet or a surface adjacent the faucet such as a tile wall (not shown). The temperature probe 20 is elongated and is configured to extend from the main body 50 of the temperature monitor to the outlet of the faucet 10 where it can be held in place with a small clip 25 that will position the active tip 20a of the temperature probe in the stream of liquid exiting the flow channel 15.

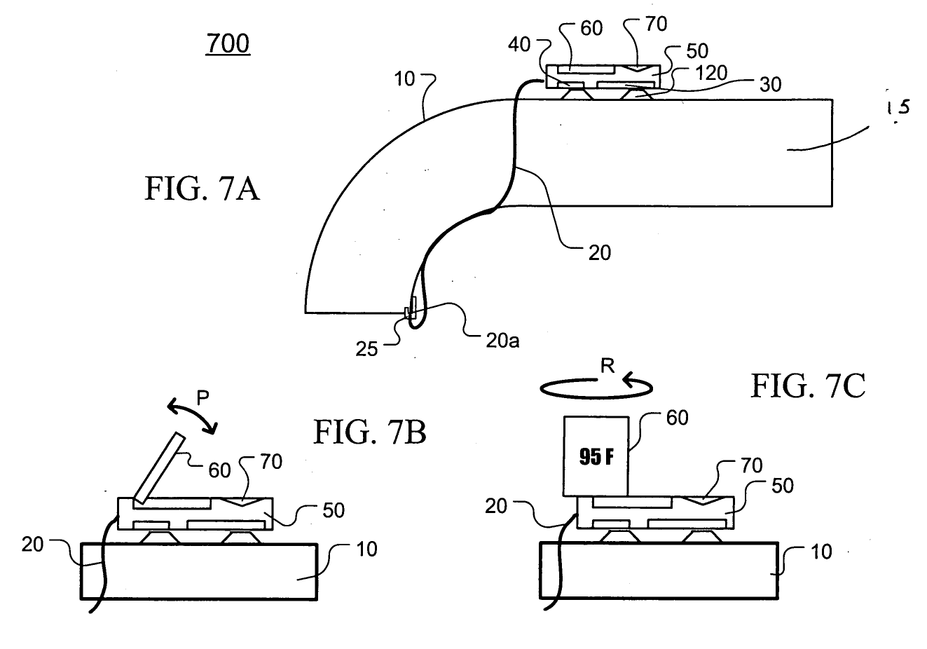

As illustrated in FIGS. 7A-7C, a seventh exemplary embodiment of the temperature monitor 700 is configured for temporary mounting on the surface of a faucet 10 that has a flow channel 15 running through it for delivering a liquid, such as water. The temperature monitor includes attachment elements 120, such as one or more suction cups, magnets or hook-and-loop devices, that allow the temperature monitor to be easily and removably mounted to the surface of the faucet 10 or a surface adjacent the faucet such as a tile wall (not shown). The temperature probe 20 is elongated and is configured to extend from the main body 50 of the temperature monitor to the outlet of the faucet 10 where it can be held in place with a small clip 25 that will position the active tip 20a of the temperature probe in the stream of liquid exiting the flow channel 15.

As illustrated in FIG. 7B, the display 60 may be configured to provide for pivotal movement P about an axis so that the angle of the display may be adjusted relative to the main body 50 to improve the viewing angle for the user. Further, as illustrated in FIG. 7C, the display may be configured to provide both pivotal and/or rotational movement R to increase the range of orientations in which the display 60 may be placed for improving the viewing angle for the user.

As will be appreciated, although several of the embodiments discussed above may utilize a battery, alternative power sources may be substituted while preserving the self-contained nature of the temperature monitor. For example, solar cells, thermoelectric and generator assemblies could be integrated, singly or in combination, to avoid the need for a battery. The solar cells and thermoelectric assemblies are especially preferred for reducing the complexity of the device and tending to reduce maintenance concerns due to the absence of moving parts.

Similarly, although the disclosed embodiments may utilize different displays, it will be appreciated that other display means may be used instead of or in addition to those discussed above including thermochromic materials selected to exhibit a distinct color change over a desired temperature range or a fluid filled thermometer that utilizes the expansion of fluid along a calibrated scale.

Still further, it will be appreciated that although the present invention has generally been described with reference to a faucet, the invention is not so limited and certain embodiments may be utilized in combination with, for example, runs of piping to indicate the temperature of the liquid flowing through the pipe. Particularly in installations having a plurality of pipes, a plurality of temperature monitors according to the present invention having light emitting devices may be used to provide a quick visual check of the operating temperatures and identification of those lines in which the temperature is not controlled to within a desired temperature range.

For example, if all liquids are within the desired temperature ranges, the plurality of temperature monitors together can comprise a “green board” that allows quick verification of the status. Other embodiments provide for the somewhat remote placement of a temperature probe to monitor the temperature of the liquid in a vessel, such as a tub, to ensure that an incapacitated person is not scalded, overheated or chilled. Similarly, a remotely positioned temperature probe can be utilized to confirm sufficient, and typically much higher, temperatures within buffet steam tables or tableware sanitizers to improve compliance with health code temperature requirements.

Embodiments of temperature monitors according to the present invention also include monitors for use by caregivers in hospitals, daycare and assisted living facilities. Such monitors allow a caregiver to ascertain the temperature of bath or treatment water readily and safely. This is particularly true of the embodiments shown in FIGS. 7B and 7C that allow a temperature indicator display to be adjusted for improved viewing by a person not directly in line with a faucet or other outlet on which it is mounted. Similarly, the embodiments shown in FIGS. 6A and 7A provide for the quick removal of the temperature monitor to allow it and/or the faucet to be more easily cleaned and disinfected.

It will be appreciated by those skilled in the art that various changes and modifications can be made to the illustrated embodiments without departing from the spirit of the present invention. All such modifications and changes are intended to be covered by the appended claims.

We claim:

1. A self-contained temperature monitor configured for attachment to a fluid passage comprising:
a main body;
a power supply;
a processing unit configured to receive power from the power supply;
a temperature probe configured for conveying data corresponding to a sensed temperature to the processing unit; and
a temperature indicator configured for emitting a signal corresponding to control signals received from the processing unit corresponding to the sensed temperature.

2. The self-contained temperature monitor according to claim 1, further comprising:
an input device for setting at least one parameter within the processing unit.

3. The self-contained temperature monitor according to claim 1, wherein the temperature indicator includes a digital display.

4. The self-contained temperature monitor according to claim 1, wherein the temperature indicator includes a plurality of light emitting devices.

5. The self-contained temperature monitor according to claim 1, wherein the temperature indicator includes a noise generator.

6. The self-contained temperature monitor according to claim 5, wherein the noise generator includes a speech synthesizer.

7. The self-contained temperature monitor according to claim 1, wherein the temperature indicator includes at least one indicator element selected from a group consisting of a thermochromic material, a fluid thermometer, a light emitting device, a digital display, a plurality of light emitting devices and a noise generator.

8. A fluid delivery system comprising:
a fluid passage;
a self-contained temperature monitoring device mounted on the fluid passage;
wherein the temperature monitoring device includes,
a temperature probe extending into the fluid passage, the temperature probe being arranged to contact fluid flowing through the fluid passage,
a power supply,
a semiconductor device, and
a temperature indicator.

9. The fluid delivery system according to claim 8, wherein the temperature indicator includes a digital display.

10. The fluid delivery system according to claim 8, wherein the temperature indicator includes a plurality of light emitting devices.

11. The fluid delivery system according to claim 8, wherein the temperature indicator includes a noise generator.

12. The fluid delivery system according to claim 11, wherein the noise generator includes a speech synthesizer.

13. The fluid delivery system according to claim 8, wherein the power supply includes at least one power source selected from a group consisting of a battery, a capacitor, a solar cell, a generator and a thermoelectric material.

14. The fluid delivery system according to claim 11, wherein the noise generator is activated upon at least one condition selected from a group consisting of a low temperature set point, a target temperature set point and a high temperature set point.

15. The fluid delivery system according to claim 12, wherein the speech synthesizer periodically announces an indicated temperature of the fluid flowing through the fluid passage.

16. The fluid delivery system according to claim 8, wherein the temperature monitoring device is arranged and configured to be mounted on a standard access fitting provided on the fluid passage.

17. The fluid delivery system according to claim 8, wherein the temperature monitoring device is arranged and configured to be mounted through a custom opening provided through the fluid passage.

18. The fluid delivery system according to claim 17, wherein the temperature monitoring device is mounted through an upper surface of the fluid passage.

19. A fluid delivery system comprising:
a fluid passage;
an opening in the fluid passage through which fluid may exit the fluid passage; and
a self-contained temperature monitoring device removably mountable adjacent the opening in the fluid passage,
wherein the temperature monitoring device includes,
an extension of the fluid passage,
a temperature probe extending into the extension of a fluid passage, the temperature probe being arranged to contact fluid flowing through the extension of the fluid passage,
a power supply,
a semiconductor device, and
a temperature indicator.

20. The fluid delivery system according to claim 19, wherein the temperature indicator includes a digital display.

21. The fluid delivery system according to claim 19, wherein the temperature indicator includes a plurality of light emitting devices.

22. The fluid delivery system according to claim 19, wherein the temperature indicator includes a noise generator.

23. The fluid delivery system according to claim 22, wherein the noise generator includes a speech synthesizer.

24. The fluid delivery system according to claim 19, wherein the power supply includes at least one power source selected from a group consisting of a battery, a solar cell, a generator and a thermoelectric material.

25. The fluid delivery system according to claim 22, wherein:
the noise generator is activated upon at least one condition selected from a group consisting of a low temperature set point, a target temperature set point and a high temperature set point.

26. The fluid delivery system according to claim 23, wherein:
the speech synthesizer periodically announces an indicated temperature of the fluid flowing through the fluid passage.

27. The fluid delivery system according to claim 19, wherein:
the fluid passage includes a faucet; and
wherein the temperature monitoring device is configured to be mounted adjacent the faucet opening.
